(19) United States
(12) Patent Application Publication
(10) Pub. No.: US 2008/0052714 A1
(43) Pub. Date: Feb. 28, 2008

(54) Method, Apparatus and Software for Managing Processing For a Plurality of Processors

(76) Inventor: Kelvin Wong, Eastleigh (GB)

Correspondence Address: LIEBERMAN & BRANDSDORFER, LLC, 802 STILL CREEK LANE, GAITHERSBURG, MD, 20878, US

(21) Appl. No.: 11/776,011

(22) Filed: Jul. 11, 2007

(30) Foreign Application Priority Data
Jul. 13, 2006 (GB) 0613923.2

(51) Int. Cl. G06F 9/46

(52) U.S. Cl. 718/102

(57) ABSTRACT

A method, apparatus or software for managing processing for a plurality of processors in a multi processor device is disclosed in which a plurality of jobs are assigned as pending jobs for processing by the processors. Each pending job and its associated task are identified. Processing is initiated by one or more of the processors of a respective pending job. In response to one of the processors completing the processing of a respective pending job, a further one of the pending jobs is selected for processing. The selection of a further pending job occurs if no other job currently being processed by any of the processors is associated with the same task as the further pending job.

### FIELD OF INVENTION

The present invention relates to a method, apparatus or software for managing processing for a plurality of processors. Particularly, but not exclusively, the invention relates to a method, apparatus or software for managing processing for a plurality of processors in a multi processor device such as an Application Specific Integrated Circuit (ASIC).

### BACKGROUND OF THE INVENTION

Data processing systems commonly comprise multiple processors that enable increased rates of instruction and data processing. Such multiprocessor systems enable multiple processors to work concurrently on a number of programs. When operating systems running on such multiprocessor platforms execute a program, the operating system creates a task for that program. A task is a combination of assembler code instructions from the program being executed and bookkeeping information used by the operating system. The task is identified with a task number or identifier, which relates the task to the program from which it originates. Many operating systems, including UNIX™, OS/2™, and Windows™, are capable of running many tasks at the same time and are called multitasking operating systems. In some operating systems, there is a one to one relationship between the task and the program. Other operating systems allow a program to be divided into multiple tasks. Such systems are called multithreading operating systems.

Tasks are made up of individual assembler code instructions referred to as jobs. Jobs are generally processed one at a time by an individual processor or engine and thus in a multiprocessor system, multiple jobs can be processed simultaneously. Jobs that belong to the same task require the multiprocessor system to provide a common resource such as memory that is unique to a given task. This common resource may be used to store partial results of calculations or bookkeeping data relating to the jobs for the given task. Thus the processing of jobs needs to be managed so as to avoid corruption of the working data in such task specific common resources. For example such corruption can occur when two processors with the data processing system simultaneously process jobs from the same task.

### SUMMARY OF THE INVENTION

In one aspect of the invention, a method is provided for managing processing for a plurality of processors. A plurality of jobs are assigned as pending jobs for processing by the processors. For each pending job, its associated task is identified. Processing is initiated by one or more of the processors of a respective pending job. In response to one of the processors completing the processing of a respective pending job, a further one of the pending jobs is selected for processing. The selection step only selects the further pending job if no other job currently being processed by any of the processors is associated with the same task as the further pending job.

In another aspect of the invention, an apparatus is provided for managing processing for a plurality of processors. A plurality of jobs is assigned as pending jobs for processing by the processors. For each pending job, its associated task is identified. One or more of the processors initiates processing of a respective pending job. In response to one of the processors completing the processing of a respective pending job, a further one of the pending jobs is selected for processing only if no other job currently being processed by any of the processors is associated with the same task as the further pending job.

In yet another aspect of the invention, an article is provided with a computer readable carrier including computer program instructions configured to process jobs. Instructions are provided to assign a plurality of jobs as pending jobs for processing by the processors. For each pending job, instructions are provided to identify its associated task. In addition, instructions are provided to initiate processing by one or more of the processors of a respective pending job. In response to one of the processors completing the processing of a respective pending job, instructions are provided to select a further one of the pending jobs for processing, the selection instructions are limited to selecting the further pending job if no other job currently being processed by any of the processors is associated with the same task as the further pending job.

### BRIEF DESCRIPTION OF THE DRAWINGS

Embodiments of the invention will now be described, by way of example only, with reference to the accompanying drawings in which:

FIG. 1 is a schematic illustration of a multi processor data processing system;

FIG. 2 is a schematic illustration of further elements of the data processing system of FIG. 1;

FIGS. 3, 4a, 4b and 5 are flow charts illustrating processing carried out by the data processing system of FIG. 1; and

FIGS. 6a and 6b show a table illustrating examples of the processing of the data processing system of FIG. 1.

### DETAILED DESCRIPTION OF PREFERRED EMBODIMENTS OF THE INVENTION

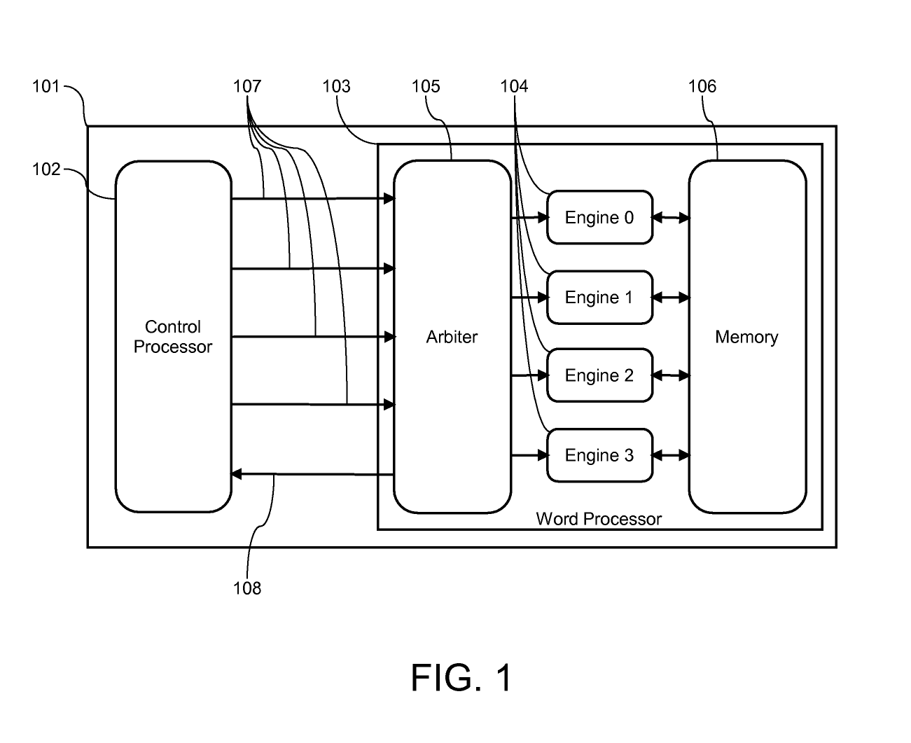

With reference to FIG. 1, a multiprocessor data processing device (101) in the form of an Application Specific Integrated Circuit (ASIC) comprises a control processor (102), which communicates with a work processor (103). The control processor (102) is arranged to control the processing of tasks and assign jobs for execution by the work processor (103). The work processor 103 is arranged to work on a maximum number of jobs simultaneously and the control processor (102) is arranged to assign no further jobs if the maximum number of jobs are still being processed.

The work processor (103) comprises four engines (104), each of which can work on one job at a time. The work processor also comprises an arbiter (105) and internal memory (106). The arbiter is arranged to schedule the jobs for each of the engines (104) and the internal memory (106) to store a set of resources relating to the tasks. The control processor (102) communicates with the work processor (103) using two synchronous, clocked interfaces in the form of a job request interface (107) and a job completion interface (108). The job request interface (107) consists of four identical sets of job request signals. Each set of job request signals is known as a channel and is given an integer identifier, referred to as a channel number, from 0 to 3. Each channel consists of a request line, a task identifying bus and a job identifying bus. The request line, when asserted, indicates to the work processor (103) that processing of a given job is being requested by the task controller (102). The task identifying bus identifies the task to which the requested job belongs thereby enabling the work processor (103) to identify appropriate resources to reference in the memory (106). Data on this bus is valid on clock cycles when the request line is asserted. The job identifying bus identifies details of the specific job within the requested task. Data on this bus is valid on clock cycles when the request line is asserted.

Once the control processor (102) uses a channel to convey a request it does not use the same channel again until work processor (103) has completed the job requested using that channel. This is so that work processor (103) can use the corresponding channel number to identify to control processor (102) which jobs it has completed. The work processor (103) does this by using the job completion interface comprising a job done line and a channel number bus. The job done line used by work processor (103) to indicate to control processor (102) that processing of a job has been completed. The channel number bus is used to return the channel number of the channel on which the completed job was provided. In other words, when a job is assigned using one of the four channels described above, work processor (103) records the channel number with the job request. When that job is complete, work processor (103) drives the channel number back to control processor (102) on the channel number bus and asserts the job done line. The control processor (102) is then free to reuse the same channel to request another job. The control processor (102) can assign up to four jobs in one cycle. The work processor (103) can signal that one job is complete per clock cycle. The control processor (102) can assign jobs, from the set P of pending jobs, in any order provided that there are not more than four jobs outstanding from work processor (103). Once a job is finished it can be removed from the set P.

As noted above, the number of channels is equal to the number, n, of engines (104) in work processor (103). Thus in the present embodiment, there are four engines (104) and therefore n=4. The one to one correspondence between channel and engine 104 exists such that a job allocated using channel i, where 0<=i<n, is assigned to engine i. This imposition simplifies the design of the work processor (103) because a network of connections between every possible pairing of channel and engine (104) is not required. However, since jobs can be assigned in any order, a subset of the work processor's (103) pending requests may be for jobs belonging to the same task. The arbiter (105) is therefore arranged to ensure that no two of the engines (104) are carrying out jobs belonging to the same task. For example, a subset of the pending jobs may belong to the same task. In this case, the arbiter (105) only allows one of this subset of jobs to be processed. Only when that job is complete can another of the jobs in the subset be started. Conversely, there may be another subset of the pending jobs which all belong to different tasks. These jobs could be safely started from the moment they are requested. The arbiter (105) is therefore arranged to determine which pending jobs it is safe to start and which must be held until a time arrives when they can be started.

The arbiter (105) is implemented using synchronous logic. Therefore, some signals described below are the direct outputs of latches. An update for such signals occur at the next leading clock edge and are valid in the next clock cycle. In the description below, these signals have a prefix of “l_” to distinguish them from signals produced in combination, which update within the same clock cycle.

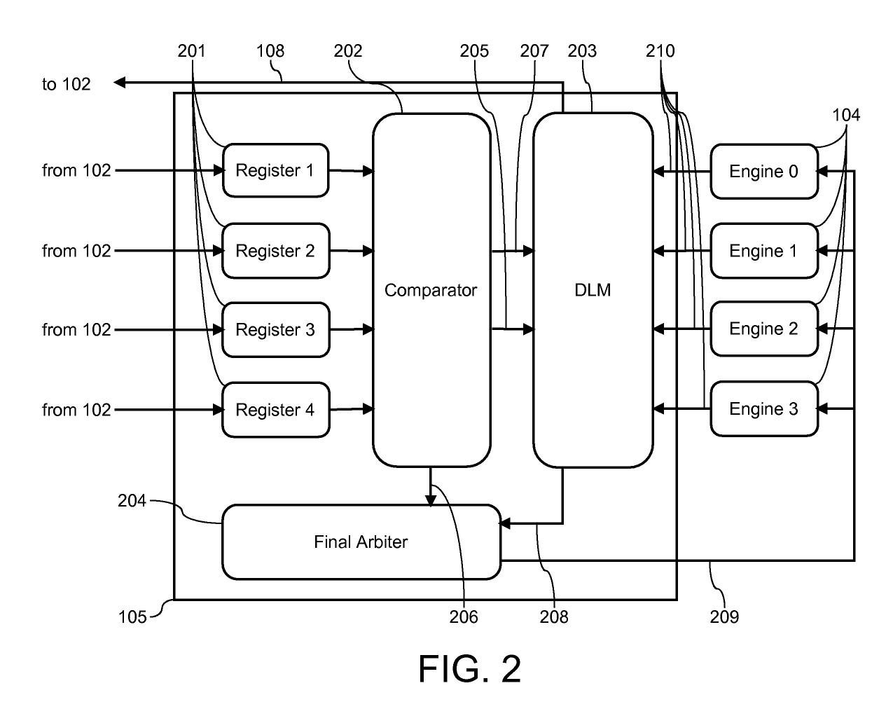

With reference to FIG. 2, the arbiter (105) comprises a set of four registers (201), a comparator (202), a duplicate list manager (DLM) (203) and a final arbiter (204). Each of the registers (201) correspond to a channel number and has a field (idᵢ) where i is the register number for channel i, which stores the task identifier for job assigned for processing on that channel by the control processor (102) along with a time stamp indicating the time the job was assigned. Each register also comprises two status bits labelled l_job_valid(i) and l_job_pending(i). The l_job_valid status bit indicates that a job has been assigned for processing, using the indicated channel, by the control processor (102). The l_job_pending status bit indicates whether or not processing of the job has been started.

Using the registers (201) the arbiter (105) is arranged to divide the set of pending jobs that have not been started into two groups referred to herein as the duplicate set and the non-duplicate set. A job in the duplicate set is a job that cannot be started immediately and must therefore be stalled because it belongs to the same task as some other job, which has already been started, but not yet completed, by the work processor (103). A job in the non-duplicate set is a job which could be started immediately because none of the engines (104) in work processor (103) are currently working on a job belonging to the same task. On each clock cycle, the arbiter 105 determines whether to assign a job from the duplicate or non-duplicate set. If an engine 104 completes a job whose task matches a job from the duplicate set then it will start that job. If there is no such job in the duplicate set the invention selects a job from the non-duplicate set for processing.

The comparator (202) comprises combinatorial logic arranged to compare the task identifiers in the registers (201). The comparator block is arranged to produce the following outputs:
1. An n-bit (where n=4) bus (205) called duplicate_pending in which the bits are designated 0 to n−1. When duplicate_pending(i)=1 (0<=i<n), then some other channel j (0<=j<n; j≠i) at that particular clock cycle has a job which has already been started (but not yet completed) and belongs to the same task as the job on channel i. In other words, the duplicate_pending bus 205 provides the data used by the DLM (203) to maintain a list comprising the duplicate set of pending jobs as described in further detail below. The job on channel i is herein referred to as a duplicate job which thus makes channel i a duplicate channel. The term “duplicate” use in this description does not mean that the jobs are the same but that the jobs belong to the same task.
2. An n-bit bus (206) called non_duplicate, in which bits are designated 0 to n−1. When non_duplicate(i)=1 then no other channel in that clock cycle has had a job started (and not yet completed) which belongs to the same task as the job on channel i. In other words, the non_duplicate bus 206 provides the data used by the final arbiter when deciding which of all the pending jobs to start next, as described in further detail below.
3. N log₂ n-bit channel_matched buses (207), each bus is labelled from 0 to n−1. If duplicate_pending(i)=1 then channel_matched(i) indicates the number of the engine which is carrying out a job which belongs to the same task as the job assigned on channel i.

When control processor (102) pulses a request line on a given channel, the task identifier is loaded into the corresponding register (201). The l_job_valid bit is set to 0 and the l_job_pending bit is set to 1 indicating that the job is pending but its processing has not been started. The register (201) outputs are then valid and usable on the next clock cycle when they are fed into a combinatorial network of the comparator (202). The first stage of the comparator block produces the duplicate pending data, which indicates whether the task identifier for one channel is the same as the task identifier for another channel. In other words, the output of a comparison between two channels i and j is signal eq_{i,j} and there is such a signal for every possible pairing of channels. The equation for eq_{i,j} is:
e_{i,j}=(idᵢ≡idⱼ), where 0<=j<n, 0<=i<n and i≠j

The eq_{i,j} signals are then used to derive n signals called dup where dup(i) (0<=i<n) is defined as:
dup(i)=(∃j: 0≦j<n i≠j: eq_{i,j} l_job_valid(j))

In other words, when dup(i)=1 then with respect to channel i there exists some other channel j whose job has already been started by an engine and belongs to the same task as the job of channel i. The signals duplicate_pending(i) and non_duplicate(i) on their respective busses (205), (206) described above now become:
duplicate_pending(i)= [symbol] job_valid(i) [symbol] job_pending(i) [symbol] dup(i) [symbol] [symbol] l_on_list(i);
and
non_duplicate(i)= [symbol] job_valid(i) [symbol] job_pending(i) [symbol] [symbol] dup(i) [symbol] [symbol] l_on_list(i)

The l_on_list(i) is a signal produced in the DLM (203) and used to indicate whether or not a job for channel i has been placed on the duplicate list and is set to 0 initially for all values of i where 0<=i<n. When l_on_list(i) is set, this causes duplicate_pending(i) to be set to 0 in the next clock cycle. This prevents the same channel number from being reloaded because it is now marked as being on the duplicate list. The duplicate_pending(i) and non_duplicate(i) signals produced by the comparator (202) and used in the DLM (203) are reset as soon as l_on_list(i) is set to 1. The processing of these signals is described in further detail below.

The comparator (202), as described above, also produces output on the channel_matched(i) buses (207), which are defined as follows:
channel_matched(i)=0, when eq₀,i [symbol] job_valid(0) [symbol] i≠0 else
=1, when eq_{1,i} [symbol] job_valid(1) [symbol] i≠1 else;
=2, when eq_{2,i} [symbol] job_valid(2) [symbol] i≠2 else; and
=n−1, when eq_{n-1,i} [symbol] job_valid(n−1) [symbol] i≠n−1

As described above, the DLM (203) maintains and updates a list of pending duplicate jobs called the duplicate list. The duplicate list, in the present embodiment, is implemented using latches. There are n−1 slots in the duplicate list and each slot contains a duplicate list entry, which has two fields, l_field_A and l_field_B. l_field_A is a log₂ n-bit wide field and can thus store any integer value from 1 to n−1. The entry in slot 1 is the earliest entry to be placed on the list. If the field has a value of i this means the job for channel i belongs to the same task as some other channel's job which in turn has already been started by an engine. l_field_B is also a log₂ n-bit wide field and indicates the number of that other channel. The DLM (203) also maintains a register, called l_next_free_slot, which is used to indicate the next free slot into which an entry may be placed. The l_next_free_slot register is initialized to 1 on system start up.

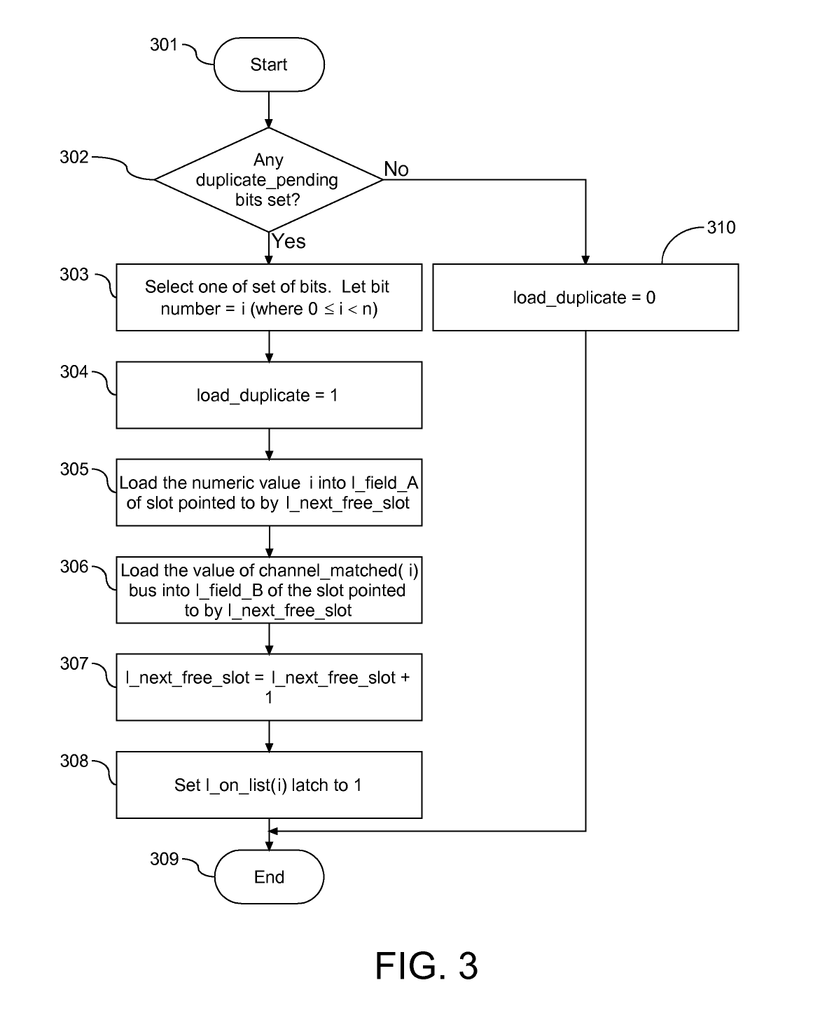

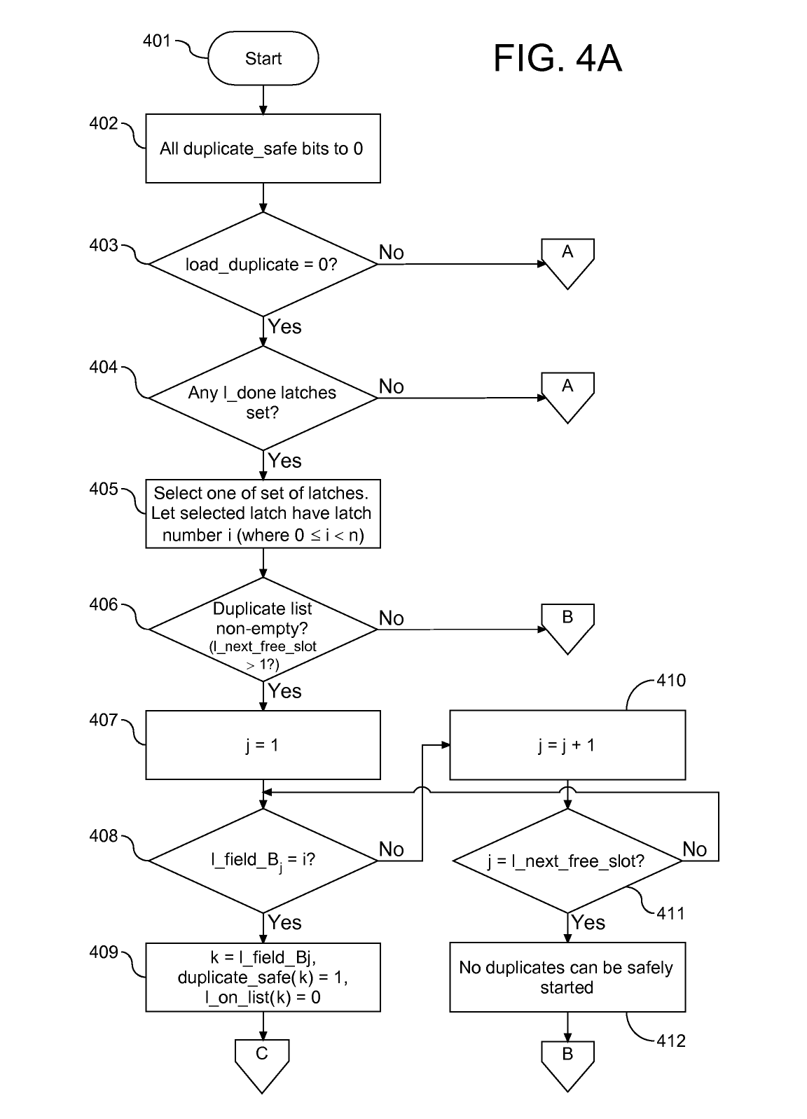

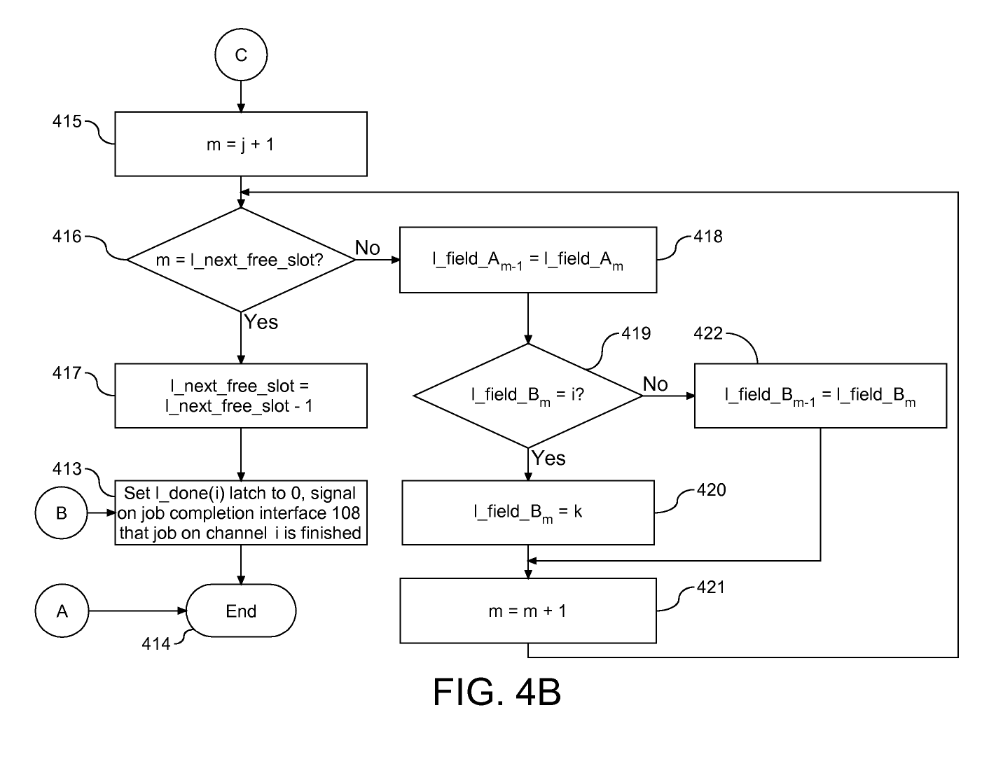

The DLM (203) has an n-bit output bus (208) to the final arbiter 204 called duplicate_safe. If bit i of duplicate_safe (208) is 1 then this means that the job of channel i, which was previously stalled because some other engine was working on a job belonging to the same task, is now safe to be chosen as the next job to be started. Each clock cycle the DLM (203) is arranged to perform one of a first and second tasks. While these tasks are referred to as the first and second tasks, no order of processing is implied by the use of these terms. The first task is to load new duplicate channel numbers onto the duplicate list as described further below with reference to FIG. 3. The second task is to determine whether any channels on the duplicate list can have jobs started and to encode that information onto the duplicate_safe bus (208) as described further below with reference to FIGS. 4a & 4b. In each clock cycle both algorithms begin processing but the first task sets a flag called load_duplicate, which the second task reads. By the time the second task reads the load_duplicate flag, it will have been set by the first task. If the flag is set to 1 then the second task quits and the first task continues. If the flag is set to 0 then the first task quits and the second task continues. In other words, if the first task determines that there are new duplicates to load into the duplicate list then it does so. If not, it determines whether any channels on the duplicate list can have jobs started.

When the DLM (203) has determined which jobs on the duplicate list should remain stalled and which can be started, it passes this information onto the final arbiter (204) for a final decision. The final arbiter (204) ultimately decides which job to start (if any can be started) when two or more jobs are eligible for processing and takes its inputs from the non_duplicate bus (206) from the comparator (202) and the duplicate_safe bus (208) from the DLM (203). In the present embodiment, the method used for selecting one of the eligible jobs is a round robin algorithm based on the channel number. The final arbiter (204) drives a bus called the start_job bus (209), which is an n-bit bus, each bit connected to a respective engine (104). To start a job in a particular cycle, the final arbiter (204) is arranged to send a one-cycle pulse along the line of the start_job bus (209) associated with the appropriate engine (104). Each engine (104) has a 1-bit bus (210) to the DLM (203) called engine_done. When an engine completes its assigned job, it sends a one-cycle pulse to the DLM (203) along the engine_done bus (210). This sets a latch l_done(i) where i is the number of the engine (104) completing the job. At the same time, l_job_valid(i) latch in the corresponding register (201) is set to 0.

FIG. 3 shows the algorithm carried out by the DLM (203) for the first task of loading new channel numbers. At step (301), the processing begins each clock cycle and at step (302), the duplicate_pending bus (205) from the comparator (202) is read to determine if any bits are set. If so, processing moves to step (303) where the set bit i with the earliest time stamp is selected and processing moves to step (304) where the internal flag called load_duplicate is set to 1. If more than one bit has the earliest time stamp then a round robin algorithm is used to select one of those bits. Processing then moves to step (305) where the numeric value of the selected bit i is loaded into the l_field_A slot pointed to by l_next_free_slot, and processing moves to step (306). At step (306), the corresponding value of the channel_matched bus (207) is loaded into the l_field_B slot pointed to by l_next_free_slot, and processing moves to step (307). At step (307), l_next_free_slot is incremented and processing moves to step (308) where the l_on_list latch is set to 1 for the bit i. Processing then moves to step (309) where processing ends for the clock cycle. If at step (302), the duplicate_pending bus (205) had no bits set then processing would move to step (310) where load_duplicate is set to 1 and processing then ends at step (309) as described above.

FIGS. 4a & 4b show the algorithm performed by the DLM (203) for determining whether there are any duplicate channels on the duplicate list whose jobs can be started. Processing starts at step (401) each clock cycle and moves to step 402 where all of the bits of duplicate_safe bus (208) are set to 0. Processing then moves to step (403) where the load_duplicate flag is inspected and if it has been set to 0, processing then moves to step (404). At step (404), the l_done latches are checked and if any are set, indicating a free engine (104), processing moves to step (405). At step (405), the latches i with the earliest time stamp are selected. If more than one bit has the same earliest time stamp then a round robin algorithm is used to select one of those bits. Processing then moves to step (406) where whether or not the duplicate list is empty is determine by inspecting the value of l_next_free_slot. If this has a value greater than 1, the duplicate list is not empty so processing moves to step (407) where a variable j is set to the value 1. Processing then moves to step (408) where a search of the duplicate list is initiated by inspecting the field l_field_Bⱼ and if it is equal to i then processing continues to step (409). At step (409), a variable k is set to the value of l_field_Bⱼ and the corresponding bit of the duplicate_safe bus (208) is set to the value 1, indicating that the job from the duplicate list identified in step (408) is safe to be processed by an engine (104). If at step (408), the field l_field_Bⱼ is not equal to i then processing moves to step (410) where the variable j is incremented and processing continues to step (411). At step (411), the value of l_next_free_slot is inspected and if it is not equal to the value of the variable j then processing then returns to step (408) and processing continues as described above but with the variable j incremented. If at step (411), the value of l_next_free_slot is equal to the value of the variable j then none of the pending jobs on the duplicate list can be processed (412). Processing then moves to step (413) of FIG. 4b where the l_done latch for i is set to the value 0 and the DML signals to the control processor (102) via the job completion interface (108) that the job on channel i has been completed. Processing then ends at step (414) for the given clock cycle.

If at steps (403) or (404) described above, the load_duplicate flag is inspected and has been set to 1 or the l_done latches are checked and none are set, processing moves to step (414) in FIG. 4b, where processing ends for the given clock cycle. If at step (406), the duplicate list is empty, in other words, the value of l_next_free_slot is equal to 1, the duplicate list is empty, therefore processing moves to step (413) in FIG. 4b and continues as described above.

From step (409) described above, processing continues to step (415) in FIG. 4b where a variable m is assigned the value of the variable j incremented by one. Processing then moves to step (416) where if the value of m is equal to the value of l_next_free_slot, processing moves to step (417). At step (417), the l_next_free_slot pointer is decremented and processing moves to step (413) and continues as described above. If at step (416), the value of m is not equal to the value of l_next_free_slot, processing moves to step (418). At step (418), the field l_field_Aₘ₋₁ of the duplicate list is assigned the value of the field l_field_Aₘ and processing moves to step (419). If at step (419), the value in field l_field_Bₘ is equal to i then processing moves to step (420) where the value of the field l_field_Bₘ is assigned to a variable k. Processing then moves to step (421) where the variable m is incremented and processing moves t step (416) and continues as described above. If at step (419), the value in field l_field_Bₘ is not equal to i then processing moves to step (422). At step (422), the field l_field_Bₘ₋₁ of the duplicate list is assigned the value of the field l_field_Bₘ and processing moves to step (421) and continues as described above.

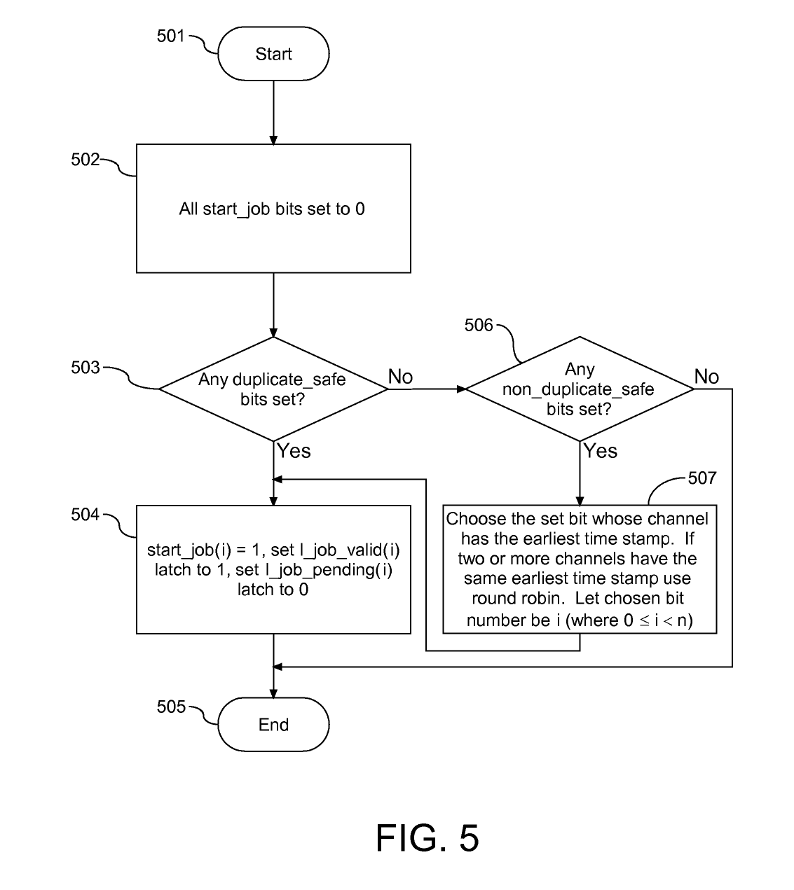

FIG. 5 shows the algorithm for the final arbiter (204) when determining whether the next job to be processed should be from the duplicate list or from the set of non-duplicate jobs. Each clock cycle processing starts at step (501) and moves to step (502) where all of the bits of the start_job bus (209) are set to 0. Processing then moves to step (503) where the duplicate_safe bus (208) is inspected to determine if any of its bits are set. If any bit of the duplicate_safe bus (208) is set then processing moves to step (504) where for the set bit i the start_job bus (209) is set to 1, the l_job_valid latch is set to 1 and the l_job_pending latch is set to 0. Processing of the job on channel i then processed by the associated engine (104) and processing ends at step (505).

If at step (503), no bits of the duplicate_safe bus (208) are set then processing moves to step (506) where the non_duplicate_safe bus (206) is inspected. If any bit of the non_duplicate_safe bus (206) is set then processing moves to step (507). At step (507), the set bit i with the earliest time stamp is selected. If two or more bits have the same earliest time stamp then a round robin algorithm is used to select one of these bits. Processing then moves to step (504) and proceeds as described above. If at step (506), the non_duplicate_safe bus (206) is inspected and no bits of the non_duplicate_safe bus (206) are set then processing moves to step (505) where processing ends for the clock cycle.

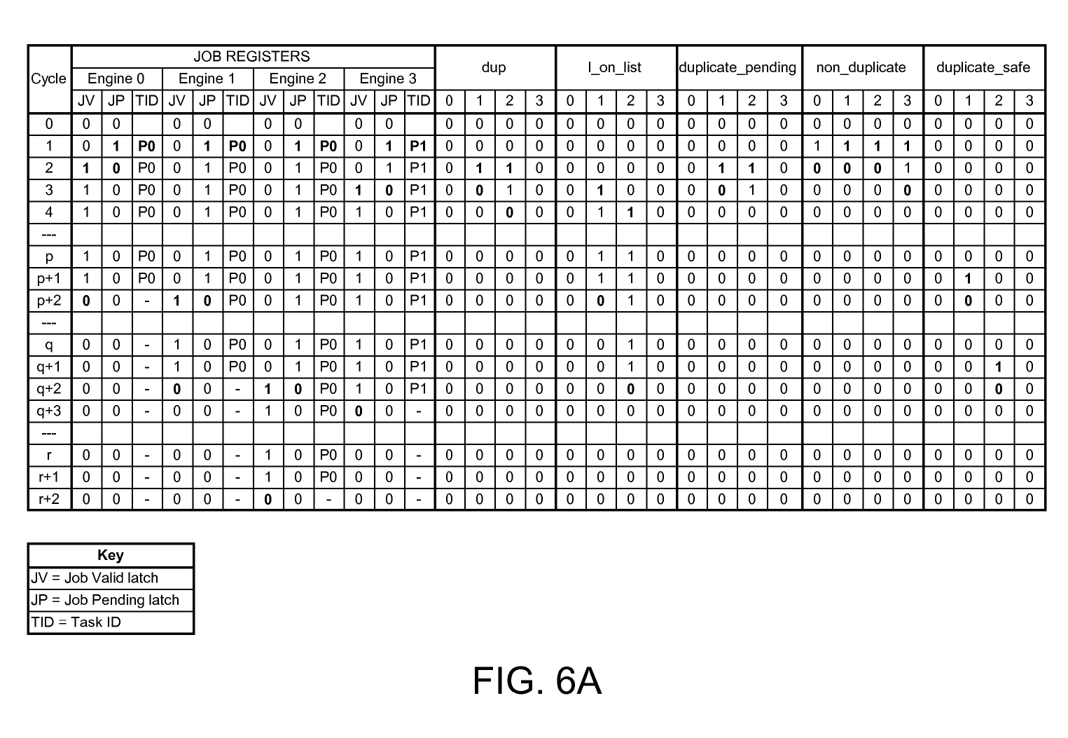

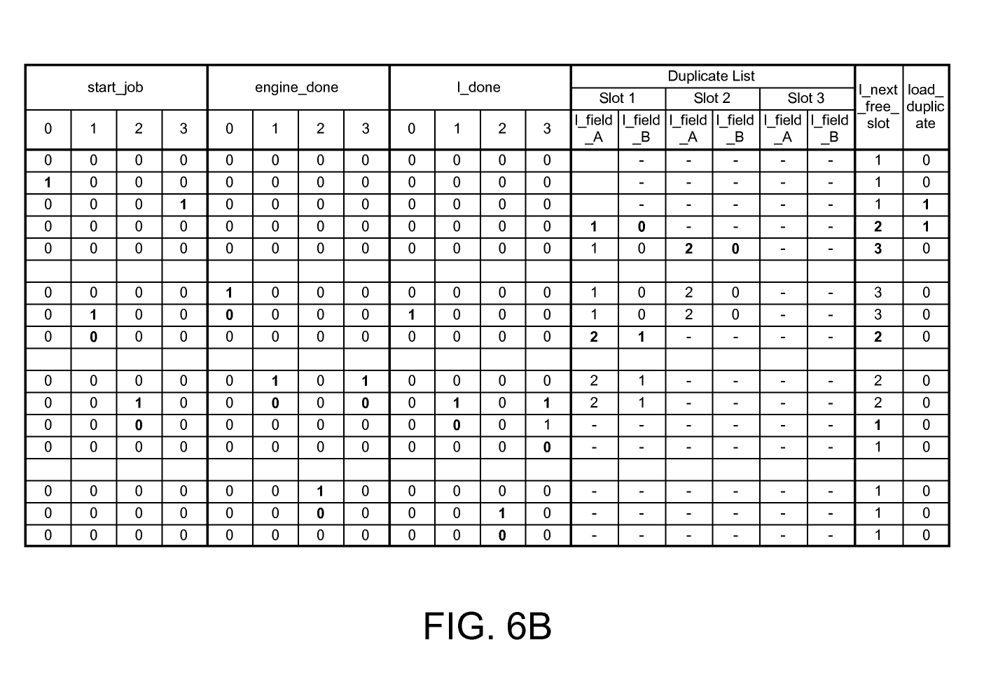

FIGS. 6a & 6b comprise a table showing the data held in the registers, lists and buses described above during a set of worked examples. The control processor (102) has assigned four jobs to work processor (103), three of which belong to the same task labelled P0. The fourth belongs to another task labelled P1. Table 1 shows, on a cycle by cycle basis, how the internal signals determine which of the pending jobs to assign and which to hold during each clock cycle.

In cycle 0, work processor (103) is at Idle having not received any job requests from control processor (102) prior to this cycle. In this cycle, control processor (102) requests the following jobs on the following channels:

Channel 0: Job j0 of Task P0

Channel 1: Job j1 of Task P0

Channel 2: Job j2 of Task P0

Channel 3: Job j0 of Task P1

In cycle 1, the outputs of Job Registers 0-3 are now valid having been loaded with the details of the requests made in Cycle 0. Since the duplicate list is empty and no engines have been started yet, all bits on the non_duplicate bus (206) are set and no bits on the duplicate_safe bus (208) are set. The final arbiter (204) must choose a set bit from the non_duplicate bus (206) since there no candidates from the duplicate_safe bus (208). The final arbiter (204) chooses bit 0 using a round-robin arbitration algorithm and the job on Channel 0 is started.

In cycle 2, the latch l_job_valid(0)=1. In other words, the job on Channel 0 has been started. This causes results in non_duplicate(0) becoming 0. Channels 1 and 2 are now duplicates of Channel 0 and thus they are stalled. Therefore, duplicate_pending(1) and duplicate_pending(2) are both set to 1 and non_duplicate(1) and non_duplicate(2) are both set to 0. Only Channel 3 is now classified as a non-duplicate. The duplicate list is still empty in this cycle, thus no duplicate_safe bits are set. The final arbiter (204) must choose a set bit from the non_duplicate bus (206). It must choose bit 3 as this is the only bit set. Thus the job on Channel 3 is started. The DLM (203) has duplicates to be loaded onto the duplicate list. It picks one of the set duplicate_pending bits. It chooses bit 1 using a round-robin arbitration algorithm and thus the details of Channel 1 are loaded into the next free slot, slot 1, of the duplicate list. The data in slot 1 will be valid in the next cycle.

In cycle 3 latch l_job_valid(3)=1 to indicate that the job on Channel 3 has started. Slot 1 now stores the details of Channel 1. In l_field_A₁ the value of 1 has been loaded to indicate that Channel 1 is a duplicate and as it is a duplicate of Channel 0. l_field_B₁ has been loaded with 0. The DLM (203) still has one more duplicate to load, Channel 2. It loads the details of Channel 2 into the next free slot, slot 2. The data in slot 2 will be valid in the next cycle.

In cycle 4, both Channels 1 and 2 are now loaded onto the duplicate list. They both indicate, from their l_field_B values that Channel 0 is holding them up. No duplicate_safe bits can be set because the job for Channel 0 is still in progress. There are no outstanding non_duplicate bits. The final arbiter (204) cannot assign any new job until the job on Channel 0 has been completed.

In cycle p, an arbitrary number cycles after Cycle 4, engine 0 reports it has completed its job. This will cause the l_done(0) latch to be set to 1 for the next cycle. In cycle p+1, now that l_done(0)=1 the DLM (203) searches the duplicate list, beginning with slot 1, to see whether there any duplicates of Channel 0. It finds that Channel 1 is the first such duplicate in the list because l_field_B₁=0 and thus duplicate_safe(1)=1. The final arbiter (204) detects that a bit on the duplicate_safe bus (208) has been set and selects the job on Channel 1 to being processing. The DLM (203) updates the duplicate list and the l_on_list(1) and l_done(0) latches accordingly and these updates will be valid for the following cycle.

In cycle p+2, the latch l_job_valid(1)=1 to indicate that the job on Channel 1 has started. Slot 1 of the duplicate list now indicates that Channel 2 is a duplicate of Channel 1. The latch l_on_list(1) has been set to 0, leaving Channel 2 as the only entry on the duplicate list. The latch l_done(0) has been reset to 0 and the latch l_job_valid(0) has been reset to 0 due to being selected by the DLM (203) during cycle p+1.

In cycle q, an arbitrary number of cycles after cycle p+2, Engines 1 and 3 report that they have completed their jobs. This causes latches l_done(1) and l_done(3) to be 1 in the next cycle. In cycle q+1, there are l_done latches set and the DLM 203 selects one of these latches using a round robin arbitration algorithm. The DLM (203), beginning with slot 1, searches the duplicate list to see whether there are any duplicates of Channel 1. It finds, in Slot 1, that Channel 2 is the first such duplicate in the list and thus sets duplicate_safe(2)=1. The final arbiter (204) sees that duplicate_safe(2) has been set and so chooses to start the job on Channel 2. The DLM (203) must update the duplicate list and the l_on_list(2) and l_done(1) latches. These updates will be valid by the next cycle. Only the l_done(3) latch, which is set to 1, remains to be processed by the DLM (203). Since the duplicate list is empty there can be no duplicates of the job on channel 3. l_done(3) can therefore be reset without any further action. There are no more outstanding jobs to be started by the final arbiter (204).

In cycle q+2, the latch l_job_valid(2)=1 indicating that the job on Channel 2 has started. l_on_list(2) has been set to 0 leaving the duplicate list empty and l_done(1) has been reset to 0. l_job_valid(1) has been reset to 0 due to channel 1 being selected in DLM (203). In cycle q+3, the latch l_done(3) has now been reset to 0 and the latch l_job_valid(3) has been reset to 0 since Channel 3 has been selected by DLM (203).

In cycle r, an arbitrary number of cycles after Cycle q+3, Engine 2 reports that it has completed its job. This will cause latch l_done(2) to be set to 1 in the next cycle. In cycle r+1, l_done(2)=1 but the duplicate list is empty. Therefore there can be no duplicates of Channel 2 and latch l_done(2) can be reset without any further action. There are no more outstanding jobs to be started. In cycle r+2, the latch l_done(2) has now been reset to 0, as has l_job_valid(2). The system is then becomes idle.

As will be understood by those skilled in the art, the system described above can be extended to include values of n, the number of engines and channels, of any size and that are not necessarily integer powers of 2. In the case where n is an integer power of 2 certain buses are log₂ n bits wide. In the case where n is not an integer power of 2, these buses become log₂ q bits wide where (2^{p}<n≦2^{q}) [symbol] (q=p+1) [symbol] (n, p, q ε+Z) and +Z is the set of non-negative integers. 25 In another embodiment, the restriction that a given engine must be used for requests made using a designated channel is lifted. Connections or routing are therefore provided between all channels and all engines. For every task, that is every set of jobs, the work processor (103) stores a queue. The work processor (103) also keeps a list of the tasks currently being worked on by each engine. When a request for a job belonging to a particular task is raised, the request gets recorded onto the queue for that task. When one of work processor (103)'s engines becomes free, the arbiter searches firstly for a non-empty queue. When it finds one, it determines which task the job at the head of the queue belongs to. It then checks its list to see if any engines are currently working on a job for that task. If not, it assigns the job at the head of the queue to the free engine. If an engine is already working on a job for that task, it finds another non-empty queue.

In one embodiment, the method may include identifying a first set of pending jobs identified as being associated with the same task as any job currently being processed by any of the processors and selecting the further one of the pending jobs for processing from the first set of pending jobs. In addition, the method may include the further steps of identifying a second set of pending jobs identified as being not associated with the same task as any job currently being processed by any of the processors and selecting the further one of the pending jobs for processing from the second set of pending jobs if no member of the first set is identified for selection.

Optionally, if a plurality of the pending jobs is identified for selection then a further selection of one of the identified pending jobs may be based on a predetermined rule. The rule may be arranged to enable the further selection of one of the identified pending jobs in dependence on the earliest identified pending job to be assigned as such a pending job for processing by the processors. The predetermined rule may be arranged to enable the further selection of one of the identified pending jobs in accordance with a round robin selection process. Each of the plurality of pending jobs may be assigned to a queue, the queue being assigned to one of the processors, prior to being processed by the designated processor and if in step d) no the pending job is identified for selection then processing by the designated processor is stalled. Each queue may hold a single job.

Each of the plurality of pending jobs may be assigned to one of a plurality of queues prior to being processed by a processor, the pending jobs being selectable from any of the queues for processing by any available processor. A plurality of queues may be provided for each processor. Each of the plurality of pending jobs may be assigned to a single queue prior to being processed by a processor, with the pending jobs being selectable from the queue for processing by any available processor, the selection being applied to each pending job in the queue in the order of assignment of the pending jobs to the queue.

Each queue may also include a job register arranged to hold an identification of the associated task for each job in the queue and an identification of whether or not the job is currently being processed by any of the processors. The processors may be engines of an ASIC. The steps may be embodied in the source code of an ASIC.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the scope of applicant's general inventive concept.

1. A method for managing processing for a plurality of processors, comprising:
assigning a plurality of jobs as pending jobs for processing by said processors;
for each pending job, identifying its associated task;
initiating processing by one or more of said processors of a respective pending job; and
selecting a further one of said pending jobs for processing in response to one of said processors completing said processing of said respective pending job, including limiting said selection of said further pending job when no other job currently being processed by any of said processors is associated with a same task as said further pending job.

2. A method according to claim 1, further comprising identifying a first set of pending jobs identified as being associated with the same task as any job currently being processed by any of said processors and selecting said further one of said pending jobs for processing from said first set of pending jobs.

3. A method according to claim 2, further comprising identifying a second set of pending jobs identified as being not associated with the same task as any job currently being processed by any of said processors and selecting said further one of said pending jobs for processing from said second set of pending jobs when no member of said first set is identified for selection.

4. A method according to claim 1, further comprising assigning each of said plurality of pending jobs to a queue, said queue being assigned to one of said processors, prior to being processed by said designated processor and when none of said pending job is identified for selection stalling processing by said designated processor.

5. A method according to claim 1, wherein each of said plurality of pending jobs is assigned to a single queue prior to being processed by a processor, said pending jobs being selectable from said queue for processing by any available processor, said selection being applied to each said pending job in said queue in the order of assignment of said pending jobs to said queue.

6. A method according to any of claim 4, wherein each queue comprises a job register arranged to hold an identification of the associated task for each job in said queue and an identification of whether or not said job is currently being processed by any of said processors.

7. A method according to claim 1, wherein said processors are engines of an ASIC.

8. An apparatus for managing processing for a plurality of processors comprising:
a plurality of jobs assigned as pending jobs for processing by said processors;
an identification of an associated task for each pending job;
one or more of said processors to initiate processing of a respective pending job; and
in response to completion of said processing of a respective pending job by one of said processors, a selection of a further one of said pending jobs for processing when no other job currently being processed by any of said processors is associated with the same task as said further pending job.

9. The apparatus according to claim 8, further comprising a first set of pending jobs identified as being associated with the same task as any job currently being processed by any of said processors and to select said further one of said pending jobs for processing from said first set of pending jobs.

10. The apparatus according to claim 9, further comprising a second set of pending jobs identified as being not associated with the same task as any job currently being processed by any of said processors and to select said further one of said pending jobs for processing from said second set of pending jobs if no member of said first set is identified for selection.

11. The apparatus according to claim 8, further comprising a queue to receive assignment of a pending job, said queue being assigned to one of said processors, prior to being processed by said designated processor and if no said pending job is identified for selection then processing by said designated processor is stalled.

12. The apparatus according to claim 8, wherein each of said plurality of pending jobs is assigned to a single queue prior to being processed by a processor, said pending jobs being selectable from said queue for processing by any available processor, said selection being applied to each said pending job in said queue in the order of assignment of said pending jobs to said queue.

13. The apparatus according to claim 11, further comprising each queue comprising a job register arranged to hold an identification of the associated task for each job in said queue and an identification of whether or not said job is currently being processed by any of said processors.

14. The apparatus according to claim 8, wherein said processors are engines of an ASIC.

15. An article comprising:
a computer readable carrier including computer program instructions configured to process jobs, comprising:
instructions to assign a plurality of jobs as pending jobs for processing by processors;
instructions to identify an associated task for each pending job;
instructions to initiate processing by one or more of said processors of a respective pending job; and
instructions to select a further one of said pending jobs for processing in response to one of said processors completing said processing of said respective pending job, including limiting said selection of said further pending job when no other job currently being processed by any of said processors is associated with the same task as said further pending job.

16. The article according to claim 15, further comprising instructions to identify a first set of pending jobs identified as being associated with the same task as any job currently being processed by any of said processors and instructions to select said further one of said pending jobs for processing from said first set of pending jobs.

17. The article according to claim 16, further comprising instructions to identify a second set of pending jobs identified as being not associated with the same task as any job currently being processed by any of said processors and instructions to select said further one of said pending jobs for processing from said second set of pending jobs when no member of said first set is identified for selection.

18. The article according to claim 15, further comprising instruction to assign each of said plurality of pending jobs to a queue, said queue being assigned to one of said processors, prior to being processed by said designated processor and when none of said pending job is identified for selection then stalling processing by said designated processor.

19. The article according to claim 15 wherein each of said plurality of pending jobs is assigned to a single queue prior to being processed by a processor, said pending jobs being selectable from said queue for processing by any available processor, said selection being applied to each said pending job in said queue in the order of assignment of said pending jobs to said queue.

20. The article according to any of claim 18, wherein each queue comprises a job register arranged to hold an identification of the associated task for each job in said queue and an identification of whether or not said job is currently being processed by any of said processors.
